(19) United States
(12) Patent Application Publication
(10) Pub. No.: US 2024/0367390 A1
(43) Pub. Date: Nov. 7, 2024

(54) LASER WELDING OF CONTINUOUS FIBER REINFORCED THERMOPLASTIC COMPOSITES

(71) Applicant: Edison Welding Institute, Inc., Columbus, OH (US)

(72) Inventors: Miranda Marcus, Columbus, OH (US); Jeff Ellis, Columbus, OH (US); Matt Nitsch, Columbus, OH (US)

(21) Appl. No.: 18/142,535

(22) Filed: May 2, 2023

(51) Int. Cl. B29C 65/16

(52) U.S. Cl. CPC B29C 65/1635; B29C 65/1632; B29K 2105/08; B29K 2307/04; B29K 2309/08

(57) ABSTRACT

A system and method for joining continuous fiber reinforced thermoplastic composites, comprising a first continuous fiber reinforced thermoplastic composite; a second continuous fiber reinforced thermoplastic composite positioned in a weld configuration with the first continuous fiber reinforced thermoplastic composite; and a laser of a predetermined wavelength having a predetermined spot size that applies a predetermined amount of power to a predefined region of the first composite and the second composite at a predetermined speed, thereby creating a weld between the first composite and the second composite.

### BACKGROUND

The disclosed technology relates in general to systems and methods for joining composite materials to one another, and more specifically to systems, devices, and methods for joining continuous fiber reinforced thermoplastic composites using laser welding for various industrial and commercial applications.

Continuous fiber reinforced thermoplastic composites (CFRTPCs) are increasingly being used in the aerospace, automotive, and energy sectors due to their low cost, recyclability, complex shape adaptability, high strength, and low weight. Proper joining of CFRTPCs is critical when designing and repairing products made of such thermoplastic composites.

Conventional systems and methods for joining CFRTPCs include significant drawbacks. For example, adhesive bonding is widely used, but requires tight tolerances for composite surface treatments, time, temperature, force, and humidity to ensure the adhesive cures as expected. Metal fasteners can be used for new designs but can rarely be used for repairs. Metal fasteners often add weight, stress concentration, require additional plies of composite around a hole location, and are subject to corrosion. Resistance welding is another joining technology used with CFRTPCs, but often creates issues with uniformity in a weld. For example, some areas of a weld may not be heated enough, while other areas may be heated to the point of polymer degradation.

Laser welding has previously been used to join CFRTPCs to unfilled polymers, for example in lap joining polyphenylsulfide (PPS) reinforced with carbon fiber to unfilled PPS. However, such techniques only involve joining CFRTPCs to unfilled polymers. To overcome the deficiencies of existing laser-based techniques, there is an ongoing need for a fast-bonding approach that uses laser welding techniques such as through transmission laser welding (TTLW) or conductive laser welding to join two CFRTPCs together in a manner that results in a strong, lightweight, and inexpensive final product, while eliminating the need of mechanical fasteners or adhesives. Additionally, a CFRTPC to CFRTPC joining approach that uses TTLW in a manner that permits two translucent or translucent glass filled composites to be welded together without the need for an additional, absorbing filler in one of the composites would also be of value.

### SUMMARY

The following provides a summary of certain example implementations of the disclosed technology. This summary is not an extensive overview and is not intended to identify key or critical aspects or elements of the disclosed technology or to delineate its scope. However, it is to be understood that the use of indefinite articles in the language used to describe and claim the disclosed technology is not intended in any way to limit the described technology. Rather the use of “a” or “an” should be interpreted to mean “at least one” or “one or more”.

One implementation of the disclosed technology provides a system for joining continuous fiber reinforced thermoplastic composites. The system comprises a first continuous fiber reinforced thermoplastic composite; a second continuous fiber reinforced thermoplastic composite positioned in a weld configuration with the first continuous fiber reinforced thermoplastic composite; and a laser with a predetermined wavelength having a predetermined spot size that applies a predetermined amount of power to a predefined region of the first composite and the second composite at a predetermined speed, thereby creating a weld between the first composite and the second composite.

The system may use through transmission laser welding to join the first composite and the second composite at the predefined region. The first composite may include an engineered polymer reinforced with continuous glass fiber, wherein the second composite may include an engineered polymer reinforced with continuous glass fiber, continuous carbon fiber, or continuous glass fiber with an absorbing filler. The engineered polymer of the first composite may be polyphenylene sulfide, polyetherimide, or polyamide, wherein the engineered polymer of the second composite may be polyphenylene sulfide, polyetherimide, or polyamide. The predetermined wavelength of the laser is at least 1.2 μm when the engineered polymer of the first composite is reinforced with continuous glass fiber and the engineered polymer of the second composite is reinforced with continuous glass fiber. The system may use conductive laser welding to join the first composite and the second composite at the predefined region. The first composite may include an engineered polymer reinforced with continuous carbon fiber, wherein the second composite may include an engineered polymer reinforced with continuous carbon fiber. The engineered polymer of the first composite may be polyphenylene sulfide, polyetherimide, or polyamide, wherein the engineered polymer of the second composite may be polyphenylene sulfide, polyetherimide, or polyamide. The weld configuration of the system may be a lap weld or a butt weld.

Another implementation of the disclosed technology provides a first method for joining continuous fiber reinforced thermoplastic composites. The first method comprises positioning a first continuous fiber reinforced thermoplastic composite in a weld configuration with a second continuous fiber reinforced thermoplastic composite; and using a laser with a predetermined wavelength having a predetermined spot size to apply a predetermined amount of power to a predefined region of the first composite and the second composite at a predetermined speed, thereby creating a weld between the first composite and the second composite.

The method may use through transmission laser welding to join the first composite and the second composite at the predefined region. The first composite may include an engineered polymer reinforced with continuous glass fiber, wherein the second composite may include an engineered polymer reinforced with continuous glass fiber, continuous carbon fiber, or continuous glass fiber with an absorbing filler. The engineered polymer of the first composite may be polyphenylene sulfide, polyetherimide, or polyamide, wherein the engineered polymer of the second composite may be polyphenylene sulfide, polyetherimide, or polyamide. The predetermined wavelength of the laser is at least 1.2 μm when the engineered polymer of the first composite is reinforced with continuous glass fiber and the engineered polymer of the second composite is reinforced with continuous glass fiber. The system may use conductive laser welding to join the first composite and the second composite at the predefined region. The first composite may include an engineered polymer reinforced with continuous carbon fiber, wherein the second composite may include an engineered polymer reinforced with continuous carbon fiber. The engineered polymer of the first composite may be polyphenylene sulfide, polyetherimide, or polyamide, wherein the engineered polymer of the second composite may be polyphenylene sulfide, polyetherimide, or polyamide.

Still another implementation of the disclose technology provides a second method for joining continuous fiber reinforced thermoplastic composites. The second method comprises positioning a first continuous fiber reinforced thermoplastic composite in a weld configuration with a second continuous fiber reinforced thermoplastic composite, wherein the first composite comprises an engineered polymer reinforced with continuous glass fiber, and wherein the second composite comprises an engineered polymer reinforced with continuous glass fiber, continuous carbon fiber, or continuous glass fiber with an absorbing filler; and using through transmission laser welding to join the first composite with the second composite, wherein a laser with a predetermined wavelength having a predetermined spot size applies a predetermined amount of power to a predefined region of the first composite and the second composite at a predetermined speed, thereby creating a weld between the first composite and the second composite.

The engineered polymer of the first composite may be polyphenylene sulfide or polyetherimide, wherein the engineered polymer of the second composite may be polyphenylene sulfide or polyetherimide. The predetermined wavelength of the laser is at least 1.2 μm when the engineered polymer of the first composite is reinforced with continuous glass fiber and the engineered polymer of the second composite is reinforced with continuous glass fiber.

It should be appreciated that all combinations of the foregoing concepts and additional concepts discussed in greater detail below (provided such concepts are not mutually inconsistent) are contemplated as being part of the technology disclosed herein and may be implemented to achieve the benefits as described herein. Additional features and aspects of the disclosed system, devices, and methods will become apparent to those of ordinary skill in the art upon reading and understanding the following detailed description of the example implementations. As will be appreciated by the skilled artisan, further implementations are possible without departing from the scope and spirit of what is disclosed herein. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more example implementations of the disclosed technology and, together with the general description given above and detailed description given below, serve to explain the principles of the disclosed subject matter, and wherein:

FIGS. 1A-1B are top view images showing the positioning of composite specimens for through transmission laser welding, wherein FIG. 1A depicts a polymer composite reinforced with glass fibers (GF) in a lap weld configuration with a polymer composite reinforced with carbon fibers (CF); and FIG. 1B depicts a polymer composite reinforced with CF in a butt weld configuration with another polymer composite reinforced with CF;

FIG. 2 is a graph showing the percent of the power of a laser beam transmitted through GF Nylon, GF polyphenylene sulfide (PPS), GF polyetherimide (PEI), CF PEI, and CF PPS in relation to the thickness of each composite;

FIG. 3A-3H are images showing laser markings for each composite measured in FIG. 2, wherein FIG. 3A depicts a laser side of the CF PEI composite, FIG. 3B depicts a bottom side of the CF PEI composite, FIG. 3C depicts a laser side of the CF PPS composite, FIG. 3D depicts a bottom side of the CF PPS composite, FIG. 3E depicts a laser side of the GF PEI composite, FIG. 3F depicts a bottom side of the GF PEI composite, FIG. 3G depicts a laser side of the GF PPS composite, and FIG. 3H depicts a bottom side of the GF PPS composite;

FIG. 4A is a cross-sectional, macroscopic image of GF PEI composite lap welded to CF PEI composite; and FIG. 4B is the same macroscopic image of FIG. 4A showing areas of interest and laser beam projection; and

FIG. 5 is a graph showing the load at break of shear specimens, including GF PPS lap welded to CF PPS, CF PPS butt welded to CF PPS, GF PEI lap welded to CF PEI, and CF PEI butt welded to CF PEI.

### DETAILED DESCRIPTION

Example implementations are now described with reference to the Figures. Reference numerals are used throughout the detailed description to refer to the various elements and structures. Although the following detailed description contains many specifics for the purposes of illustration, a person of ordinary skill in the art will appreciate that many variations and alterations to the following details are within the scope of the disclosed technology. Accordingly, the following implementations are set forth without any loss of generality to, and without imposing limitations upon, the claimed subject matter.

The examples discussed herein are examples only and are provided to assist in the explanation of the apparatuses, devices, systems, and methods described herein. None of the features or components shown in the drawings or discussed below should be taken as required for any specific implementation of any of these the apparatuses, devices, systems or methods unless specifically designated as such. For ease of reading and clarity, certain components, modules, or methods may be described solely in connection with a specific Figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

The disclosed technology provides systems, devices, and methods for joining continuous fiber reinforced thermoplastic composites (CFRTPCs) together using through transmission laser welding (TTLW) or conductive laser welding without the need for adhesives or mechanical fasteners. Laser transmission welding to join CFRTPCs to unfilled polymers is known, but the use of TTLW and conductive laser welding to join two CFRTPCs together is a unique approach to composite part joining. Potential applications of the disclosed technology include new product development and repairs in industries such as aerospace, automotive, and energy generation, including but not limited to wind turbines. This technology allows a final product to be fabricated using a fast-bonding process to obtain a strong, lightweight, and inexpensive product. Further, some implementations of the disclosed technology enable the joining of two translucent or transparent glass filled CFRTPCs through TTLW without the need for an additional, absorbing filler in one of the composites.

Polyetherimide (PEI), which is a thermoplastic, is produced by a nitro displacement reaction involving bisphenol A, 4, 4′-methylenedianiline and 3-nitrophthalic anhydride, and exhibits high heat distortion temperature, tensile strength, and modulus. Polyphenylene sulfide (PPS), which is also a thermoplastic, is produced by the condensation polymerization of p-dichlorobenzene and sodium sulfide, and exhibits outstanding chemical resistance, good electrical properties, excellent flame retardance, low coefficient of friction, and high transparency to microwave radiation. Both PEI and PPS can be reinforced with combinations of glass fibers (GFs) and carbon fibers (CFs) to achieve CFRTPCs.

In an example implementation of the disclosed technology, composite specimens of continuous GF and CF reinforced PEI and PPS were laser welded together in a lap weld and butt weld configuration. The composite specimens included TECATEC PPS GF50 OS 50001 Natural at 0.33-mm thick, TECATEC PPS CF50 IP X0001 Natural Prepreg (M00307) at 0.25-mm thick, TECATEC PEI GF50 OS S0002 Natural (M00273) at 0.45-mm, and CF-PEI UD Gewebe Prepreg Konsolidiert (M00197) at 0.45-mm thick. The composites were sheets that contain similar fiber layup orientations of [0/90].

A Leister Novolas WS-AT laser welder was used for through transmission laser welding of the composite specimens. In this example, the laser had a maximum power of 200 watts, a wavelength of 975 nm (0.975 μm), a measured spot size of about 1.5 mm, a compaction pressure of up to 6.9 kPa, and a linear velocity of up to 750 mm/min. The pyrometer of the laser was used to vary the laser power and regulate the temperature of the composite specimens at the laser entry surface from 150° C. to 300° C.

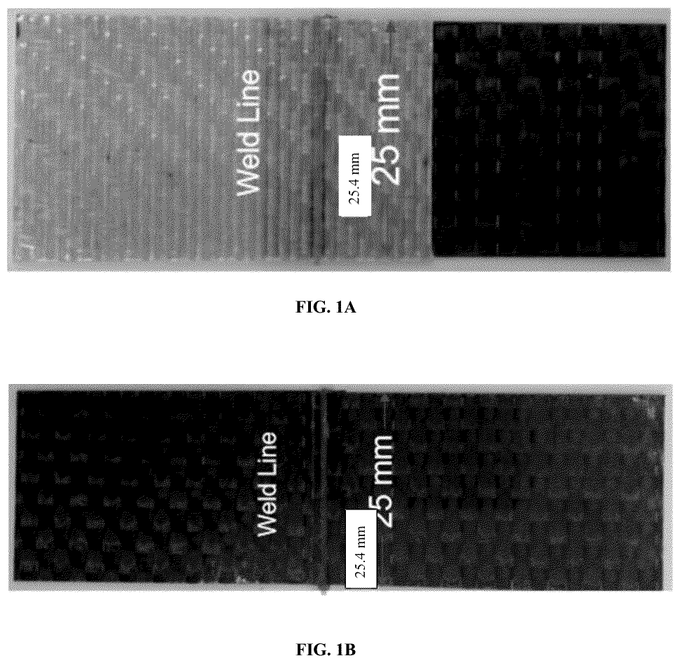

With reference to FIGS. 1A-1B, the disclosed technology was used to weld GF reinforced composite specimens to CF reinforced composite specimens in a lap weld configuration (FIG. 1A) and to weld CF reinforced specimens to other CF reinforced specimens in a butt weld configuration (FIG. 1). In this example, the TTLW process utilized the Leister Novolas WS-AT 975 nm (0.975 μm) wavelength laser at or below 200 watts with a measured spot size of approximately 1.5 mm. The CF to CF butt weld configuration had very little overlap as compared to the GF to CF lap weld configuration. As depicted in FIGS. 1A-1B, the composite specimens have a uniform width of 25.4 mm and are laser welded across the width of the specimens in a single pass. With reference to FIG. 1A, the GF reinforced specimen was positioned closer to the laser, and situated on top of the CF reinforced specimen, so the laser beam passed through the GF specimen to the interface with the CF specimen. Optimization welding trials determined the power, speed, and pyrometer temperature settings necessary to laser weld each combination of the specimens. Process experience and material expertise were relevant with regard to narrowing the settings required for acceptable or “good” welds. Good weld criteria generally includes high manual peel strength with minimal material degradation.

The spot size of the laser beam was measured using marking paper. The distance from the laser optics to the marking paper replicated the distance to the welding interface through the use of transparent polycarbonate spacers. An Optical Engineering Model P-300 gauge was used to measure the power of the laser beam through the specimens to determine laser power at the weld joint. The laser weld was visually inspected using optical microscopy. The weld line was cross-sectioned perpendicularly, then mounted in potting resin and polished. Polished samples were imaged using an optical microscope, and features such as the heat affected zone (HAZ), weld area, voids, and fibers were identified.

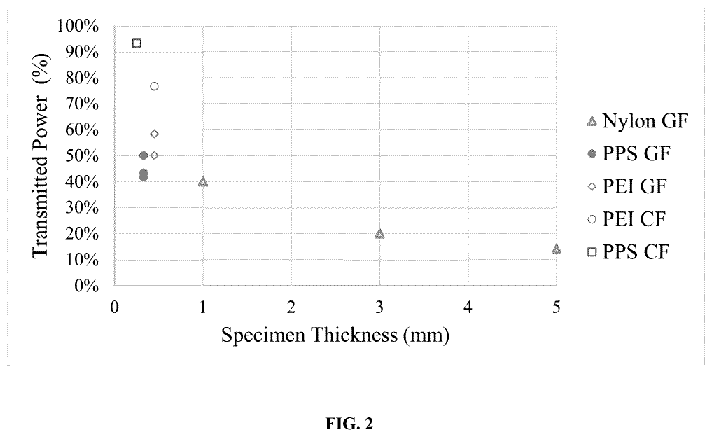

TABLE 1, below, lists optimized TTLW settings based on the thickness of example composite specimens. Optimization of laser power and speed for the thickness of each specimen were determined by visual inspection of the cross-sectional micrographs at the weld interface for a range of laser settings. Compaction pressure was 6.9 kPa during welding trials, and the laser beam spot size was measured to be 2.9±0.1 mm using laser marking paper. The laser beam power measurement was baselined by measuring power without a composite specimen between the optics and the gauge. Power was measured through all composite specimens, including a glass filled Nylon used that was considerably thicker than the composite specimens. Measurements were normalized to the baseline and graphically presented (FIG. 2). As the composite specimens increased in thickness, the transmitted power to the weld joint decreased. Heat measured through the CF reinforced specimens was greater than the heat measured through the GF reinforced specimens.

TABLE 1
Optimized Laser Welding Settings Based on Specimen Thickness.

| | | | Laser | | |
|---|---|---|---|---|---|
| | | Pyrometer | Speed | Minimum | Maximum |
| | Weld | Setting | (mm/ | Power | Power |
| Material | Type | (° C.) | min) | (W) | (W) |
| PPS GF to PPS CF | Lap | 200 | 400 | 10 | 40 |
| PPS CF to PPS CF | Butt | 180 | 400 | 10 | 40 |
| PEI GF to PEI CF | Lap | N/A | 400 | 25 | 25 |
| PEI CF to PEI CF | Butt | N/A | 400 | 25 | 25 |

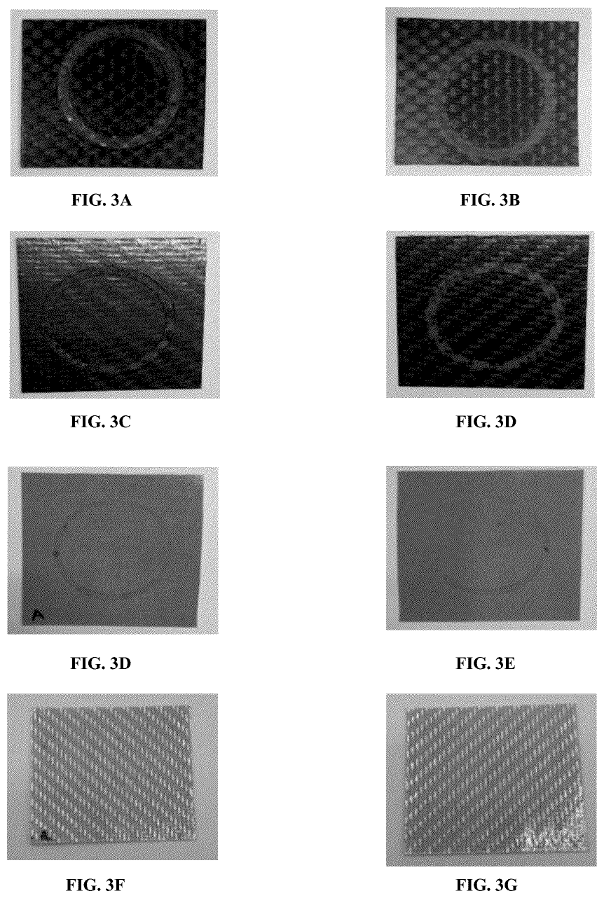

With reference to FIGS. 3A-3H, the top and bottom surfaces of the composite specimens were examined to interpret the heat measurements through the CF and GF reinforced specimens. The two polymer composites (PPS and PEI) reinforced with CF exhibited marking on the laser sided surface, indicating that the laser beam was not transmitting through the composite, but rather was heating the laser entry surface (FIGS. 3A and 3C). The bottom surfaces of the PPS and PEI reinforced with CF also exhibited marking in the same pattern as that on the laser sided surface, indicating that the heat was conducted through the composite specimens (FIGS. 3B and 3D). Carbon fiber has a high thermal conductivity which explains the high percent of measured transmitted power. Therefore, composites reinforced with CF or carbon black filler can be used as a top work piece and a weld can be made on the opposite side if the composite's thermal conductivity is high. Next, PPS reinforced with GF exhibited marking on the laser sided and bottom surface, indicating some heating of the laser entry surface (FIGS. 3E-3F). However, the markings on the laser sided surface and the bottom surface were not as pronounced as the markings on the polymer composites reinforced with CF, indicating that some of the laser beam was transmitted through the GF composite and some of the heat of the laser moved through conduction and through the fibers. Finally, PEI reinforced with GF exhibited no marking on either side of the composite, indicating that the laser beam transmitted through the polymer and the glass (FIGS. 3G-3H). The PPS composite appeared to have a smaller, tighter weave than the PEI composite, which may explain the difference in energy transfer through the GF composites. Accordingly, PEI and PPS reinforced GF composites are suitable for laser welding and PEI and PPS reinforced CF (or carbon black filler) are suitable for welding by heat conduction.

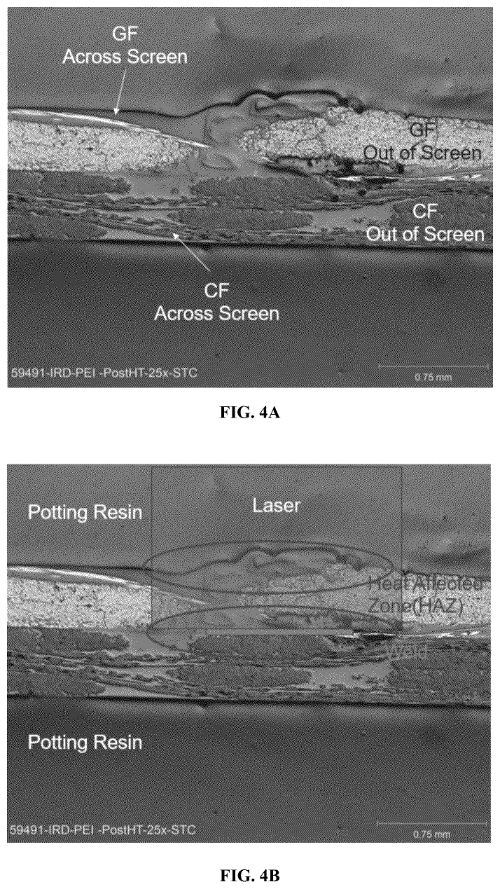

FIGS. 4A-4B depict cross-sectional, macroscopic views of PEI reinforced with GF lap welded to PEI reinforced with CF. As previously discussed, the top PEI-GF composite specimen is transmissive to the laser wavelength, while the bottom PEI-CF composite specimen is adsorptive. The weld line of the specimens is located in the middle where the PEI-GF and PEI-CF composites attach. FIG. 4B is labeled to show areas of interest and a projection of the laser beam. For example, some surface markings or flash are present where the laser entered the GF composite part. Reduction of the surface markings or flash can achieved by tuning the laser power, speed, pulsing, spot size, and number of passes. The weld at the interface is where the surfaces of the specimens can no longer be distinguished because they exhibit good intermolecular diffusion. FIGS. 4A-4B show both the GF and CF composites crossing the screen in a continuous fashion, and the ends of the fibers are visible for interweaved perpendicular fibers.

An Instron (https://www.instron.com/en-us/) testing device was used to mechanically test the strength of the composites in the lap welded and the butt-welded configurations. Composite specimens were pulled in a lap shear configuration in tension at 50.8 mm/min until failure, as recommended by ASTM D5868. All composite welds broke exclusively along the weld line. When examined, the polymer weld was observed to be strong enough to break CF and allow it to remain welded to the GF composite. The CF weave pattern caused a stress concentration on the fiber interface that resulted in this failure.

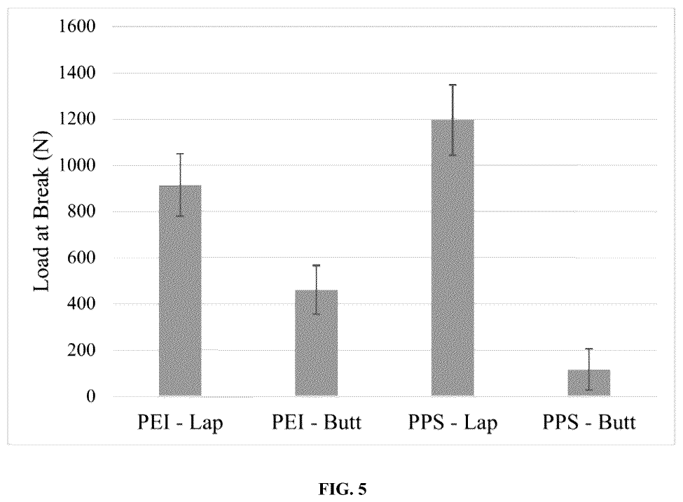

FIG. 5 is a graph showing the load at break values for the composite materials and weld types previously listed in TABLE 1. A t-test was performed on this data for PEI versus PPS composites. The p-values were less than 0.05, indicating that the composite specimens came from different populations with a 95% confidence interval for both the lap and butt specimens. The error bars are ±1 standard deviation, n=5, and all standard deviations were similar. The butt welds were observed to be weaker than the lap welds. No broken fibers were observed in the tested specimens, indicating all the strength came from only the polymer weld. Alternatively, the PPS lap weld has the highest strength (1200 N) due to the most fibers breaking. The area of each weld was approximately 25×2 mm, yielding shear strengths of up to 24 MPa.

In another example implementation of the disclosed technology, a 2 μm wavelength laser was utilized to join two CFRTPCs through TTLW. In this implementation, the systems, devices, and methods previously described for joining two CFRTPCs with a 0.975 μm wavelength laser were performed in the same application, the difference being the ability to join two translucent or transparent GF composites by TTLW without the need for an additional, absorbing filler in one of the composites. When using a 0.975 μm or 1 μm wavelength laser, the laser light did not absorb in an unfilled polymer composite, so one or the other composite should include an absorbing filler such as carbon black, which is not always desired. Conversely, increasing the wavelength of the laser to at least 1.2 μm allows the laser light to partially absorb in most polymers (including PEI and PPS). In this way, two translucent or transparent GF composites can be laser welded together without the need for an additional filler. As previously discussed for the 0.975 μm wavelength application, the thickness of composites affects overall weld strength. Thus, the thickness of the two translucent or transparent GF composites used with the at least 1.2 μm wavelength laser will affect sufficiency and strength of the weld.

All literature and similar material cited in this application, including, but not limited to, patents, patent applications, articles, books, treatises, and web pages, regardless of the format of such literature and similar materials, are expressly incorporated by reference in their entirety. Should one or more of the incorporated references and similar materials differs from or contradicts this application, including but not limited to defined terms, term usage, described techniques, or the like, this application controls.

As previously stated and as used herein, the singular forms “a,” “an,” and “the,” refer to both the singular as well as plural, unless the context clearly indicates otherwise. The term “comprising” as used herein is synonymous with “including,” “containing,” or “characterized by,” and is inclusive or open-ended and does not exclude additional, unrecited elements or method steps. Although many methods and materials similar or equivalent to those described herein can be used, particular suitable methods and materials are described herein. Unless context indicates otherwise, the recitations of numerical ranges by endpoints include all numbers subsumed within that range. Furthermore, references to “one implementation” are not intended to be interpreted as excluding the existence of additional implementations that also incorporate the recited features. Moreover, unless explicitly stated to the contrary, implementations “comprising” or “having” an element or a plurality of elements having a particular property may include additional elements whether or not they have that property.

The terms “substantially” and “about”, if or when used throughout this specification describe and account for small fluctuations, such as due to variations in processing. For example, these terms can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to 0.05%, and/or 0%.

Underlined and/or italicized headings and subheadings are used for convenience only, do not limit the disclosed subject matter, and are not referred to in connection with the interpretation of the description of the disclosed subject matter. All structural and functional equivalents to the elements of the various implementations described throughout this disclosure that are known or later come to be known to those of ordinary skill in the art are expressly incorporated herein by reference and intended to be encompassed by the disclosed subject matter. Moreover, nothing disclosed herein is intended to be dedicated to the public regardless of whether such disclosure is explicitly recited in the above description.

There may be many alternate ways to implement the disclosed technology. Various functions and elements described herein may be partitioned differently from those shown without departing from the scope of the disclosed technology. Generic principles defined herein may be applied to other implementations. Different numbers of a given module or unit may be employed, a different type or types of a given module or unit may be employed, a given module or unit may be added, or a given module or unit may be omitted.

Regarding this disclosure, the term “a plurality of” refers to two or more than two. Unless otherwise clearly defined, orientation or positional relations indicated by terms such as “upper” and “lower” are based on the orientation or positional relations as shown in the Figures, only for facilitating description of the disclosed technology and simplifying the description, rather than indicating or implying that the referred devices or elements must be in a particular orientation or constructed or operated in the particular orientation, and therefore they should not be construed as limiting the disclosed technology. The terms “connected”, “mounted”, “fixed”, etc. should be understood in a broad sense. For example, “connected” may be a fixed connection, a detachable connection, or an integral connection, a direct connection, or an indirect connection through an intermediate medium. For an ordinary skilled in the art, the specific meaning of the above terms in the disclosed technology may be understood according to specific circumstances.

It should be appreciated that all combinations of the foregoing concepts and additional concepts discussed in greater detail herein (provided such concepts are not mutually inconsistent) are contemplated as being part of the disclosed technology. In particular, all combinations of claimed subject matter appearing at the end of this disclosure are contemplated as being part of the technology disclosed herein. While the disclosed technology has been illustrated by the description of example implementations, and while the example implementations have been described in certain detail, there is no intention to restrict or in any way limit the scope of the appended claims to such detail. Additional advantages and modifications will readily appear to those skilled in the art. Therefore, the disclosed technology in its broader aspects is not limited to any of the specific details, representative devices and methods, and/or illustrative examples shown and described. Accordingly, departures may be made from such details without departing from the spirit or scope of the general inventive concept.

What is claimed:

1. A system for joining continuous fiber reinforced thermoplastic composites, comprising:
(a) a first continuous fiber reinforced thermoplastic composite;
(b) a second continuous fiber reinforced thermoplastic composite positioned in a weld configuration with the first continuous fiber reinforced thermoplastic composite; and
(c) a laser of a predetermined wavelength having a predetermined spot size that applies a predetermined amount of power to a predefined region of the first composite and the second composite at a predetermined speed, thereby creating a laser weld between the first composite and the second composite.

2. The system of claim 1, wherein the laser weld is created through transmission laser welding that joins the first composite and the second composite at the predefined region.

3. The system of claim 2, wherein the first composite includes an engineered polymer reinforced with continuous glass fiber, wherein the second composite includes an engineered polymer reinforced with continuous glass fiber, continuous carbon fiber, or continuous glass fiber with an absorbing filler.

4. The system of claim 3, wherein the engineered polymer of the first composite is polyphenylene sulfide or polyetherimide, and wherein the engineered polymer of the second composite is polyphenylene sulfide, polyetherimide, or polyamide.

5. The system of claim 3, wherein the predetermined wavelength of the laser is at least 1.2 μm when the engineered polymer of the first composite is reinforced with continuous glass fiber and the engineered polymer of the second composite is reinforced with continuous glass fiber.

6. The system of claim 1, wherein the laser weld is created through conductive laser welding that joins the first composite and the second composite at the predefined region.

7. The system of claim 6, wherein the first composite includes an engineered polymer reinforced with continuous carbon fiber, and wherein the second composite includes an engineered polymer reinforced with continuous carbon fiber.

8. The system of claim 7, wherein the engineered polymer of the first composite is polyphenylene sulfide or polyetherimide, and wherein the engineered polymer of the second composite is polyphenylene sulfide, polyetherimide, or polyamide.

9. The system of claim 1, wherein the weld configuration is a lap weld or a butt weld.

10. A method for joining continuous fiber reinforced thermoplastic composites, comprising:
(a) positioning a first continuous fiber reinforced thermoplastic composite in a weld configuration with a second continuous fiber reinforced thermoplastic composite; and
(b) using a laser of a predetermined wavelength having a predetermined spot size to apply a predetermined amount of power to a predefined region of the first composite and the second composite at a predetermined speed, thereby creating a weld between the first composite and the second composite.

11. The method of claim 10, further comprising using through transmission laser welding to join the first composite and the second composite at the predefined region.

12. The method of claim 11, wherein the first composite includes an engineered polymer reinforced with continuous glass fiber, and wherein the second composite includes an engineered polymer reinforced with continuous glass fiber, continuous carbon fiber, or continuous glass fiber with an absorbing filler.

13. The method of claim 12, wherein the engineered polymer of the first composite is polyphenylene sulfide or polyetherimide, and wherein the engineered polymer of the second composite is polyphenylene sulfide, polyetherimide, or polyamide.

14. The method of claim 12, wherein the predetermined wavelength of the laser is at least 1.2 μm when the engineered polymer of the first composite is reinforced with continuous glass fiber and the engineered polymer of the second composite is reinforced with continuous glass fiber.

15. The method of claim 10, further comprising using conductive laser welding to join the first composite and the second composite at the predefined region.

16. The method of claim 15, wherein the first composite includes an engineered polymer reinforced with continuous carbon fiber, wherein the second composite includes an engineered polymer reinforced with continuous carbon fiber.

17. The method of claim 16, wherein the engineered polymer of the first composite is polyphenylene sulfide or polyetherimide, and wherein the engineered polymer of the second composite is polyphenylene sulfide, polyetherimide, or polyamide.

18. A method for joining continuous fiber reinforced thermoplastic composites, comprising:
(a) positioning a first continuous fiber reinforced thermoplastic composite in a weld configuration with a second continuous fiber reinforced thermoplastic composite, wherein the first composite comprises an engineered polymer reinforced with continuous glass fiber, and wherein the second composite comprises an engineered polymer reinforced with continuous glass fiber, continuous carbon fiber, or continuous glass fiber with an absorbing filler; and
(b) using through transmission laser welding to join the first composite with the second composite, wherein a laser of a predetermined wavelength having a predetermined spot size applies a predetermined amount of power to a predefined region of the first composite and the second composite at a predetermined speed, thereby creating a weld between the first composite and the second composite.

19. The method of claim 18, wherein the engineered polymer of the first composite is polyphenylene sulfide or polyetherimide, and wherein the engineered polymer of the second composite is polyphenylene sulfide, polyetherimide, or polyamide.

20. The method of claim 18, wherein the predetermined wavelength of the laser is at least 1.2 μm when the engineered polymer of the first composite is reinforced with continuous glass fiber and the engineered polymer of the second composite is reinforced with continuous glass fiber.
